(19) United States
(12) Patent Application Publication
(10) Pub. No.: US 2009/0275291 A1
(43) Pub. Date: Nov. 5, 2009

(54) STORAGE DEVICE

(75) Inventors: Nobuyuki Myouga, Kawasaki (JP); Katsuhiko Takeuchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/333,105

(22) Filed: Dec. 11, 2008

(30) Foreign Application Priority Data
Apr. 30, 2008 (JP) 2008-118998

(51) Int. Cl. G06F 11/00

(52) U.S. Cl. 455/67.14

(57) ABSTRACT

A storage device controls transmission of test data and reception of the test data according to a protocol set for test mode upon receiving, for example, a test instruction, when a reception interface and a transmission interface are electrically connected together through a cable. The storage device verifies whether the test data transmitted from any one of a controller, a buffer, and a storage medium matches the test data received by any one of them.

### CROSS-REFERENCE TO RELATED APPLICATIONS

This application is based upon and claims the benefit of priority of the prior Japanese Patent Application No. 2008-118998, filed on Apr. 30, 2008, the entire contents of which are incorporated herein by reference.

### BACKGROUND

1. Field

The present invention relates to a storage device.

2. Description of the Related Art

In a conventional technology, to test an interface of a storage device, the storage device is connected to a host for test (or a chip for test having functions equivalent to those of a host for test, etc.), and data is actually transmitted and received between the host and the storage device (see, for example, FIG. 16).

There are other conventional technologies for such a test. With one conventional technology, a switching unit that connects or disconnects a transmitting unit and a receiving unit of an interface is provided in a device and is controlled to perform a test. With another conventional technology, a circuit for testing is provided inside an interface to connect the transmitting unit and the receiving unit together to perform a test. With still another conventional technology, an interface of a display is tested (see, for example, Japanese Laid-open Patent Publication Nos. H6-28272, S62-66356, 2001-282569, and H7-121397).

With the conventional technologies explained above, it is not easy to test the interface of a storage device.

For example, by connecting the storage device to a host for test, the interface cannot be tested without a host for test. Besides, if the speed of the interface increases, for example, a test cannot be performed with a previous-generation host, and a next-generation host is required. This results in increased cost.

### SUMMARY

It is an object of the present invention to at least partially solve the problems in the conventional technology.

According to an aspect of an embodiment, a storage device includes: a transmission controller that controls, in response to a test instruction to operate in test mode for testing whether data is normally transmitted and received when a signal is output from a transmission interface and input to a reception interface, transmission of test data set for the test mode according to a protocol set for the test mode, the transmission interface for data transmission and the reception interface for data reception that, when electrically connected to the transmission interface, receives the signal from the transmission interface being interfaces connected to an external device; a reception controller that controls, in response to the test instruction, reception of the test data transmitted under control of the transmission controller according to the protocol set for the test mode; and a verifying unit that verifies whether the test data transmitted under control of the transmission controller matches the test data received under control of the reception controller.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram for explaining the principle of a storage device according to a first embodiment;

FIGS. 2A to 2C are diagrams for explaining Serial ATA initialization;

FIG. 3 is a diagram for explaining the case where the Serial ATA initialization is applied to the storage device according to the first embodiment;

FIGS. 4A and 4B are diagrams for explaining Serial ATA data transmission and reception;

FIG. 5 is a flowchart for explaining a process on a data transmission side;

FIG. 6 is a flowchart for explaining a process on a data reception side;

FIGS. 7A and 7B are diagrams for explaining the case where the Serial ATA data transmission and reception is applied to the storage device according to the first embodiment;

FIGS. 8A and 8B are flowcharts for explaining a data transmission and reception process in the first embodiment;

FIG. 9 is a block diagram of the storage device according to the first embodiment;

FIG. 10 is a block diagram of an interface-protocol controller in the first embodiment;

FIGS. 11 and 12 are diagrams for explaining a comparator in the first embodiment;

FIGS. 13A to 13E are diagrams for explaining a modification of the embodiment;

FIGS. 14A to 14C are diagrams for explaining another modification of the embodiment;

FIGS. 15A to 15C are diagrams for explaining still another modification of the embodiment; and

FIG. 16 is a diagram for explaining a conventional technology.

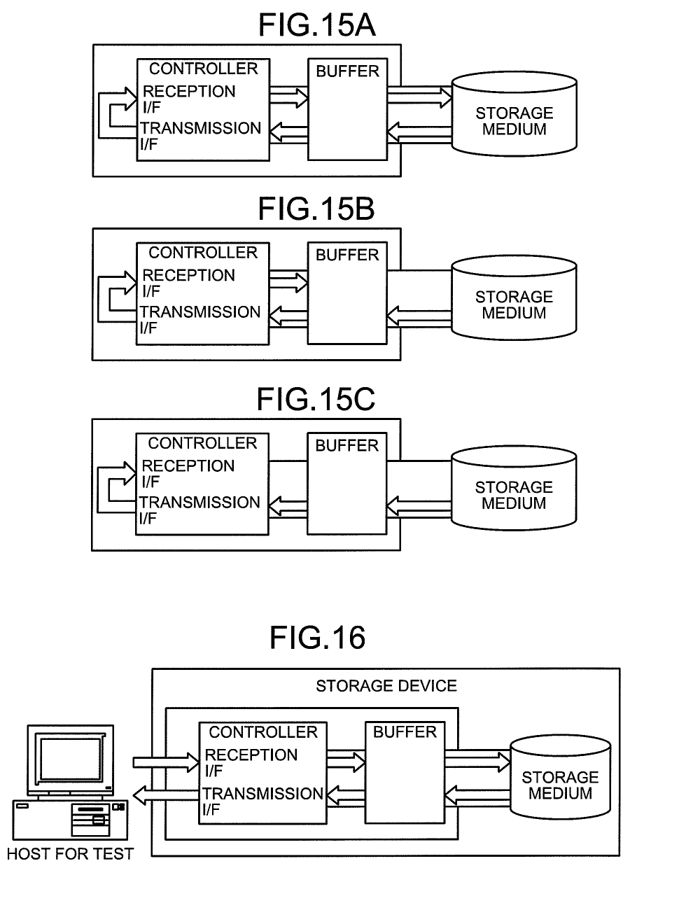

### DETAILED DESCRIPTION OF THE PREFERRED EMBODIMENTS

Exemplary embodiments of the present invention are described in detail below with reference to the accompanying drawings.

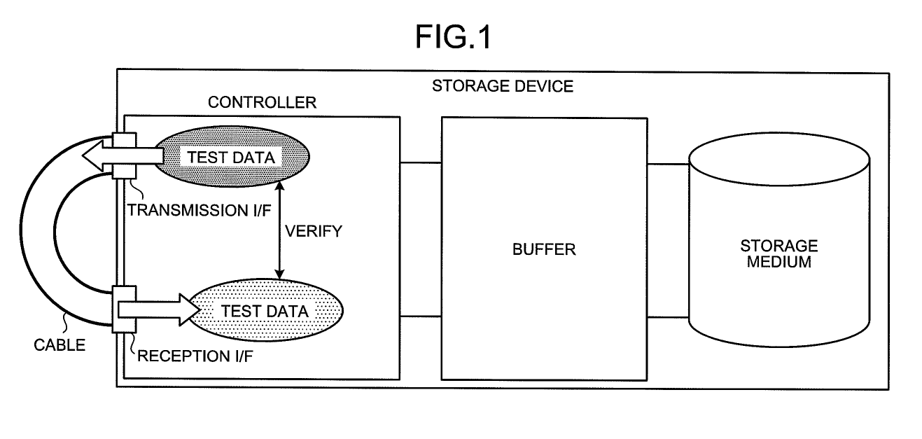

First, the principle of a storage device according to a first embodiment is explained. FIG. 1 is a diagram for explaining the principle of the storage device according to the first embodiment.

In the storage device according to the first embodiment, Serial Advance Technology Attachment (SATA) is assumed, which is a high-speed serial interface, as an example of the interface. The storage device according to the first embodiment includes, as depicted in FIG. 1, a controller, a buffer, and a storage medium. The controller includes, as depicted in FIG. 1, a reception interface and a transmission interface. The reception interface and the transmission interface are each an interface to an external device (for example, they connect the storage device to an external device via a connector on a printed board having the controller mounted thereon). The reception interface is used for data reception, while the transmission interface is used for data transmission.

Meanwhile, as depicted in FIG. 1, in the storage device according to the first embodiment, the reception interface and the transmission interface are directly connected together outside of the controller through electrical connection with a cable, for example. With this, a signal output from the transmission interface is input to the reception interface.

Under such connection, the storage device according to the first embodiment conducts a test to check whether data transmission and reception is correctly performed. Specifically, upon receiving an instruction for operation in test mode, the storage device controls transmission of test data set for test mode according to a protocol set for the test mode. The reason why transmission is controlled according to the protocol set for the test mode will be explained in detail further below.

Upon receiving an instruction for operation in the test mode, the storage device controls reception of the transmitted test data according to the protocol set for the test mode. The reason why reception is controlled according to the protocol set for the test mode will be explained in detail further below.

In this manner, as depicted in FIG. 1, the storage device according to the first embodiment receives test data transmitted from the transmission interface from the reception interface. Then, as depicted in FIG. 1, the storage device verifies whether the transmitted test data is consistent with or matches the received test data. While a specific verifying process will be explained in detail later, it is now briefly described. The storage device compares the transmitted test data with the received test data, and verifies whether they match.

In this manner, in the storage device according to the first embodiment, the interface is tested by using the scheme of directly connecting the reception interface and the transmission interface together through electrical connection with a cable, for example. With this, the interface can be easily tested.

As described below, it is assumed in the first embodiment that all data patterns of the test data are stored inside of the controller and data comparison is also performed inside of the controller. However, this is not meant to be restrictive. As described in detail later in a second embodiment, for the storage device, a configuration can be selected as appropriate such that test data stored in any one of the controller, the buffer, and the storage medium is transmitted from the transmission interface and the received test data is compared in any one of the controller, the buffer, and the storage medium.

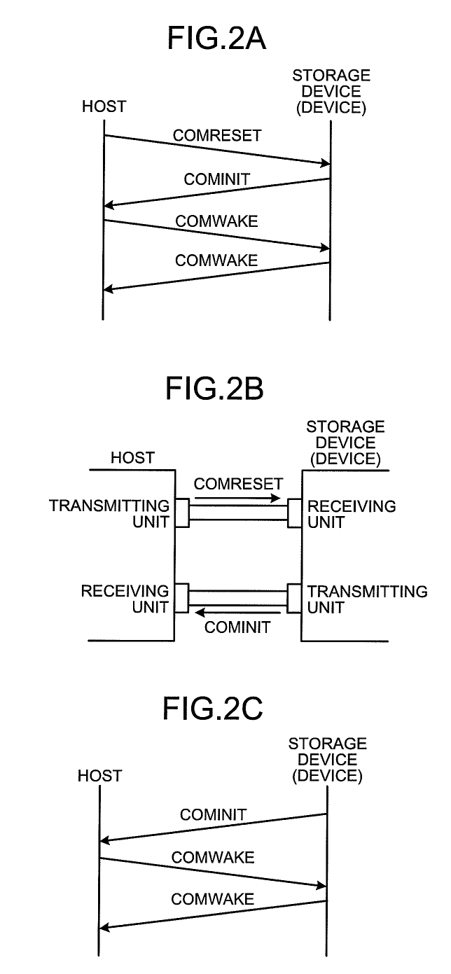

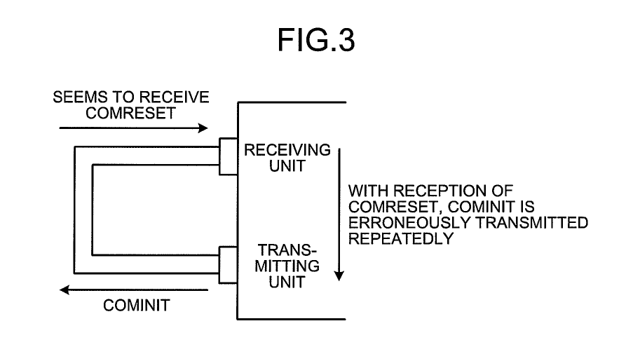

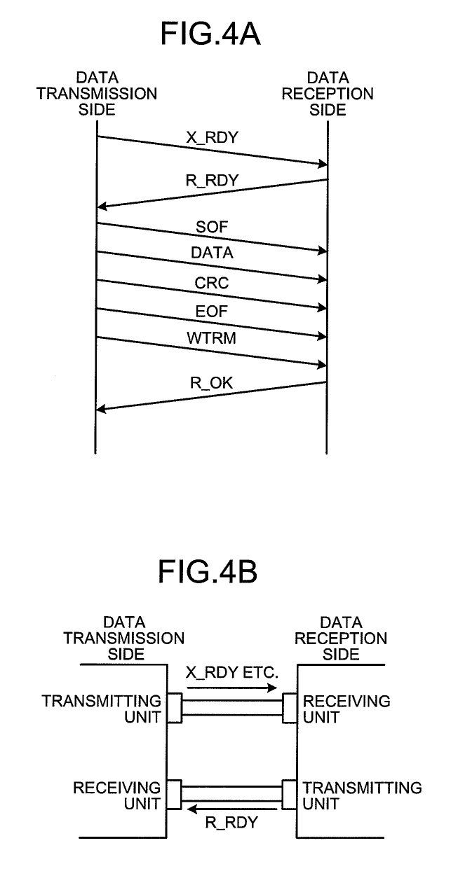

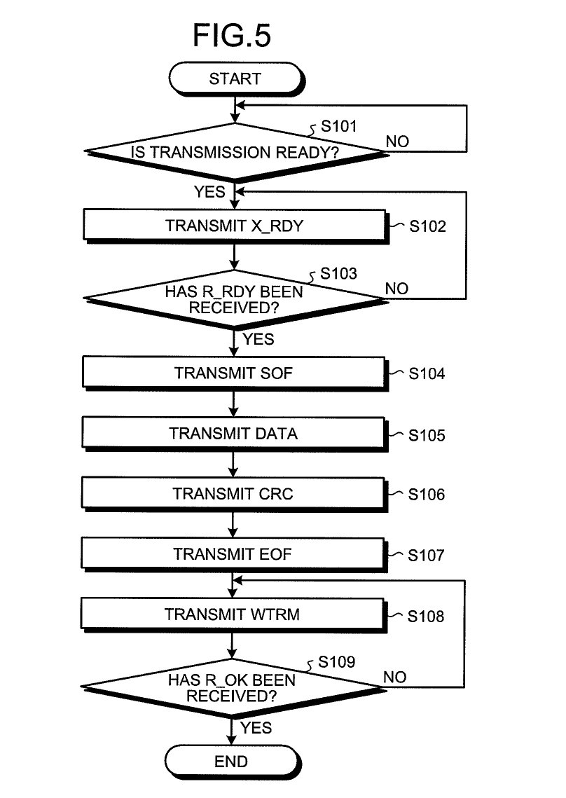

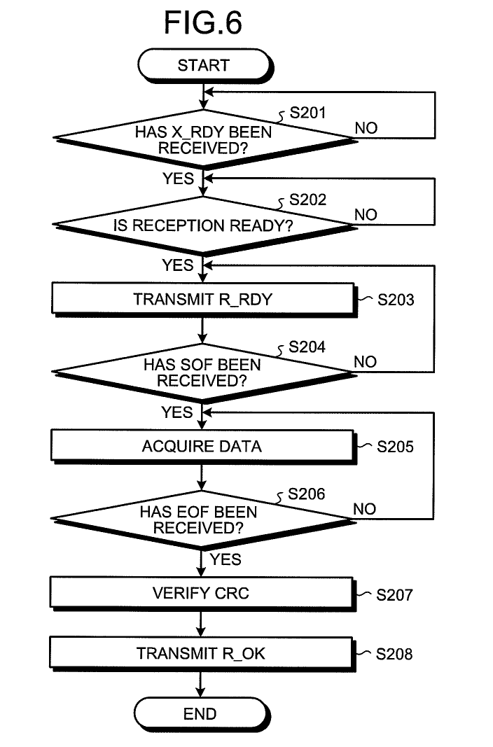

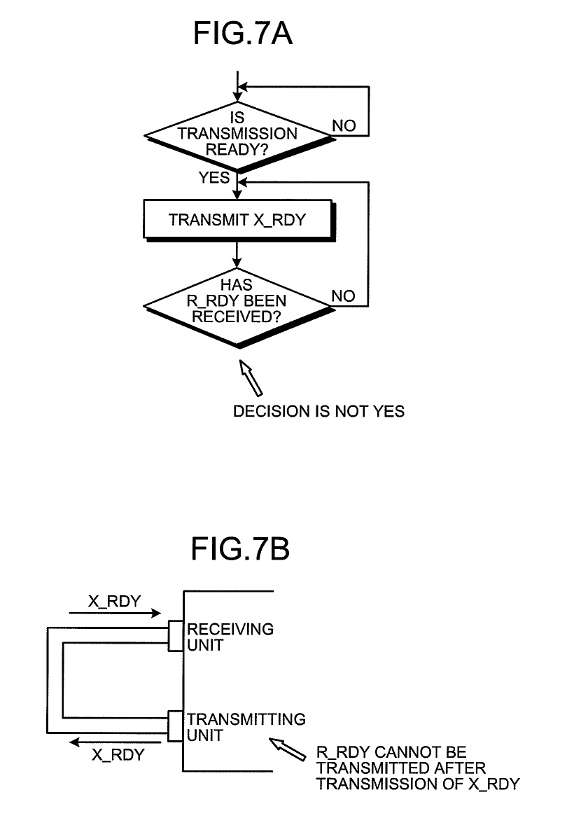

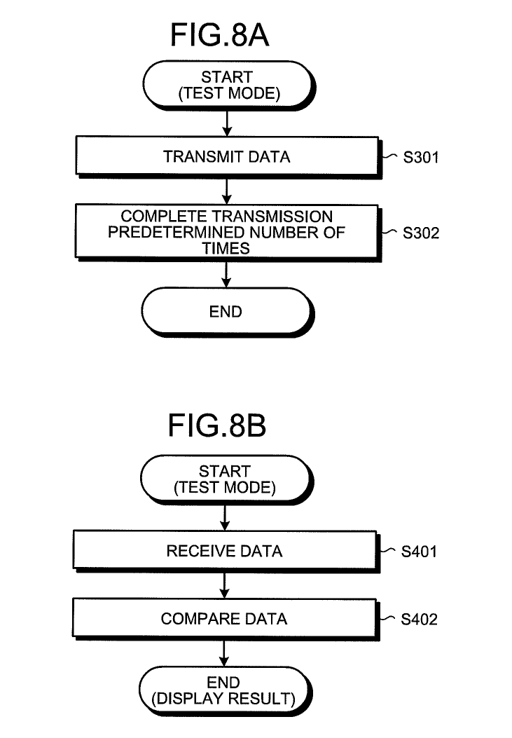

As explained above, in the storage device according to the first embodiment, test data is transmitted and received according to the protocol set for the test mode. Specifically, in the storage device according to the first embodiment, an initialization process and a data transmission and reception process for the test mode are set. With reference to FIGS. 2A to 2C, 3, 4A and 4B, 5, 6, 7A and 7B, and 8A and 8B, the initialization process and the data transmission and reception process are described below in sequence. FIGS. 2A to 2C are diagrams for explaining Serial ATA initialization. FIG. 3 is a diagram for explaining the case where the Serial ATA initialization is applied to the storage device according to the first embodiment. FIGS. 4A and 4B are diagrams for explaining Serial ATA data transmission and reception. FIG. 5 is a flowchart of a process on a data transmission side. FIG. 6 is a flowchart of a process on a data reception side. FIGS. 7A and 7B are diagrams for explaining the case where the Serial ATA data transmission and reception is applied to the storage device according to the first embodiment. FIGS. 8A and 8B are flowcharts for explaining a data transmission and reception process in the first embodiment.

First, initialization of the Serial ATA is explained. In the Serial ATA, at the time of power-up, the storage device (device) performs a process “OOB Sequence” of initializing a Phy layer with a host.

Specifically, as depicted in FIGS. 2A and 2B, between a host and the storage device, signals “COMRESET”, “COMINIT”, and “COMWAKE” are exchanged. Although “COMRESET” and “COMINIT” are electrically identical signals, “COMRESET” is a signal transmitted by the host, while “COMINIT” is a signal transmitted by the storage device. When the storage device is powered up first, as depicted in FIG. 2C, “COMRESET” is omitted, and “OOB Sequence” starts with “COMINIT”.

In either one of FIGS. 2A and 2C, a communication between the host and the storage device is not possible until initialization of a Phy layer by “OOB Sequence”. Here, a state in which initialization of the Phy layer is completed is referred to as “Phy ready state”

Meanwhile, when the transmitting unit and the receiving unit are directly connected together through electrical connection with a cable, for example, as in the storage device according to the first embodiment, the storage device cannot correctly complete “OOB Sequence”. The reason is that when the transmitting unit of the storage device transmits “COMINIT”, as depicted in FIG. 3, the receiving unit of the storage device determines that “COMRESET” has been received, which is an electrically identical signal. Then, the transmitting unit of the storage device erroneously retransmits “COMINIT”, resulting in an endless loop.

For this reason, the storage device according to the first embodiment provides test mode inside of the Phy layer, thereby omitting (bypassing) “OOB Sequence” to make a transition to “Phy ready state”.

Next, Serial ATA data transmission and reception is explained. In Serial ATA, at the time of normal data transmission and reception, the storage device or host performs a process depicted in FIGS. 4A and 4B.

Specifically explained, with reference to FIG. 4A, first, signals each indicated by a right arrow are signals transmitted from a transmitting unit on a data transmission side to a receiving unit on a data reception side, while signals each indicated by a left arrow are signals transmitted from a transmitting unit on the data reception side to a receiving unit on the data transmission side. The signals are as follows: “X_RDY” (transmission data ready) is a signal indicating that data transmission is ready. “R_RDY” (receiver ready) is a signal indicating that data reception is ready. “SOF” (start of frame) is a signal indicating the start of a data frame. “DATA” is data to be transmitted. “CRC” is data added for verifying data consistency. “EOF” (end of frame) is a signal indicating the end of the data frame. “WTRM” (wait for frame termination) is a signal for waiting for a response from the data reception side after transmission of “EOF”. “R_OK” (reception with no error”) is a signal indicating that data reception has been correctly completed.

Although not shown in FIG. 4A, while the data transmission side is transmitting “DATA”, the data reception side transmits a signal of “R_IP” (reception in progress), informing the data transmission side that the data is being received. When data reception has not been correctly completed, the data reception side transmits “R_ERR” (reception error) in place of “R_OK”.

The data transmission and reception process depicted in FIG. 4A is explained with reference to FIGS. 5 and 6 as a process on the data transmission side and a process on the data reception side.

First, the process on the data transmission side is explained with reference to FIG. 5. The transmitting unit on the data transmission side determines whether transmission is ready (Step S101). When it is determined that transmission is ready (Yes at Step S101), the transmitting unit transmits “X_RDY” to the data reception side (Step S102).

Subsequently, the transmitting unit determines whether “R_RDY” has been received (Step S103). When it is determined that “R_RDY” has not been received (No at Step S103), the process control returns to Step S102. On the other hand, when it is determined that “R_RDY” has been received (Yes at Step S103), the transmitting unit transmits “SOF” (Step S104), and then transmits “DATA” (Step S105).

The transmitting unit then transmits “CRC” (Step S106), transmits “EOF” (Step S107), and then transmits “WTRM” (Step S108).

Subsequently, the transmitting unit determines whether “R_OK” has been received (Step S109). When it is determined that “R_OK” has not been received (No at Step S109), the process control returns to Step S108. On the other hand, when it is determined that “R_OK” has been received (Yes at Step S109), the transmitting unit normally ends the process.

Next, the process on the data reception side is explained with reference to FIG. 6. The receiving unit on the data reception side determines whether “X_RDY” has been received (Step S201). When it is determined that “X_RDY” has been received (Yes at Step S201), the receiving unit then determines whether reception is ready (Step S202).

When it is determined that reception is ready (Yes at Step S202), the receiving unit transmits “R_RDY” (Step S203). The receiving unit then determines whether “SOF” has been received (Step S204). When it is determined that “SOF” has not been received (No at Step S204), the process control returns to Step S203.

On the other hand, when it is determined that “SOF” has been received (Yes at Step S204), the receiving unit acquires “DATA” (Step S205). The receiving unit then determines whether “EOF” has been received (Step S206).

When it is determined that “EOF” has been received (Yes at Step S206), the receiving unit verifies “CRC” (Step S207), transmits “R_OK” (Step S208), and then normally ends the process.

Meanwhile, when the transmitting unit and the receiving unit are directly connected together through electrical connection with a cable, for example, as in the storage device according to the first embodiment (when data is transmitted and received in a self-contained manner), the storage device cannot transmit and receive data through a normal process. The reason is that, when data is transmitted and received in a self-contained manner, the storage device becomes a data transmission side and a data reception side by itself. Thus, for example, as depicted in FIGS. 7A and 7B, at a portion of a handshake between “X_RDY” and “R_RDY”, the data transmission side waits for “R_RDY” after transmitting “X_RDY”, and cannot transmit “R_RDY”.

For this reason, the storage device according to the first embodiment is provided with test mode, thereby allowing data transmission and reception by itself. In the test mode, as depicted in FIGS. 8A and 8B, data is transmitted and received with a protocol different from a normal protocol.

FIG. 8A is a flowchart of a process on the data transmission side in the test mode. In the test mode, the data transmission side transmits “DATA” (Step S301). Having transmitted “DATA” a predetermined number of times (Step S302), the data transmission side ends the process. In this manner, the data transmission side neither transmits “X_RDY” nor waits for reception of “R_RDY”. The data transmission side transmits only “DATA”, and does not transmit “SOF”, “EOF”, and “CRC”. Furthermore, the data transmission side neither transmits “WTRAM” nor waits for reception of “R_OK”.

FIG. 8B is a flowchart of a process on the data reception side in the test mode. In the test mode, the data reception side receives “DATA” (Step S401). Upon comparing the received “DATA” (verifying consistency with the transmitted “DATA”) (Step S402), the data reception side displays the result, and ends the process. In this manner, the data reception side neither waits for reception of “X_RDY” nor transmits “R_RDY”. The data reception side neither waits for reception of “SOF” and “EOF” nor verifies “CRC”. Furthermore, the data reception side does not transmit “R_OK”.

However, since the storage device according to the first embodiment neither performs a handshake between “X_RDY” and “R_RDY” in the test mode nor transmits “SOF”, the storage device cannot determine a “DATA” intake start position when receiving “DATA”. To get around this, in one possible scheme, the intake start position is determined by setting the head data as a specific data pattern, but flexibility of the test pattern is decreased. To solve this problem, the storage device according to the first embodiment performs a verifying process as will be explained in detail later.

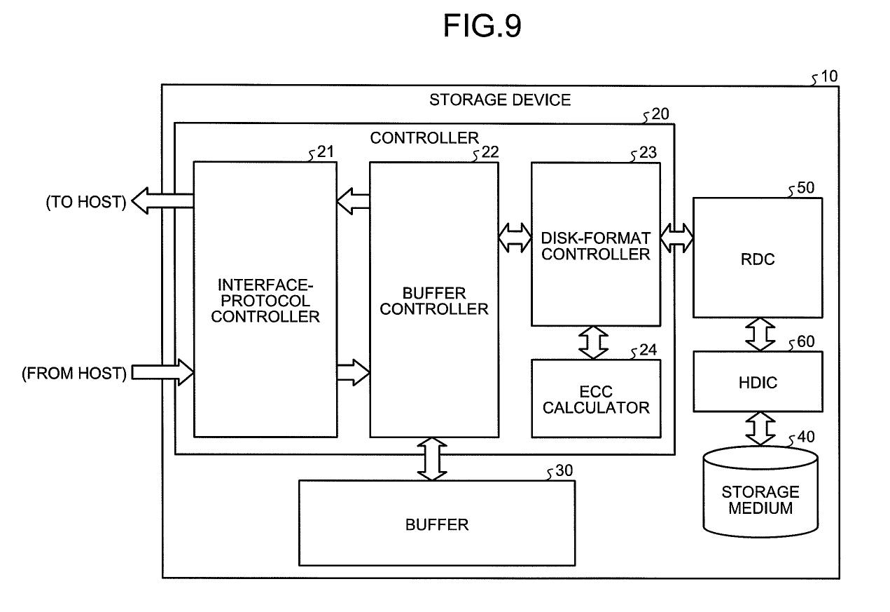

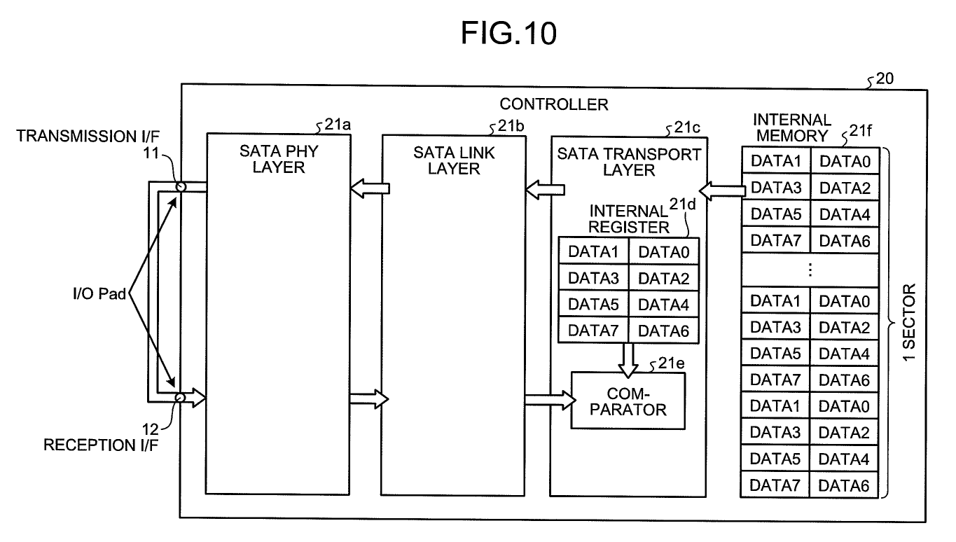

Next, the configuration of the storage device according to the first embodiment is explained with reference to FIGS. 9 and 10. FIG. 9 is a block diagram of the storage device according to the first embodiment. FIG. 10 is a block diagram of an interface-protocol controller in the first embodiment.

As depicted in FIG. 9, a storage device 10 according to the first embodiment includes a controller 20, a buffer 30, a storage medium 40, a Read Channel (RDC) 50, and a Head IC (HDIC) 60.

The controller 20 includes, as depicted in FIG. 9, an interface-protocol controller 21, a buffer controller 22, a disk-format controller 23, and an Error Correcting Code (ECC) calculator 24.

The interface-protocol controller 21 controls an interface protocol with the host. Specifically, at the time of reception of write data, the interface-protocol controller 21 transmits data received from the host to the buffer controller 22. At the time of transmission of read data, the interface-protocol controller 21 transmits data received from the buffer controller 22 to the host.

Upon receiving an instruction for operation in the test mode, the interface-protocol controller 21 according to the first embodiment controls transmission of test data set for the test mode according to a protocol set for the test mode. Specifically, the interface-protocol controller 21 transmits test data stored in an internal memory at an arbitrary location inside of the controller 20 according to the protocol set for the test mode. Upon receiving an instruction, the interface-protocol controller 21 controls reception of the transmitted test data according to the protocol set for the test mode.

The buffer controller 22 controls read and write of data stored in the buffer 30. Specifically, at the time of reception of write data, the buffer controller 22 once writes data received from the interface-protocol controller 21 in the buffer 30, reads the data at an appropriate timing from the buffer 30, and then transmits the data to the disk-format controller 23. At the time of transmission of read data, the buffer controller 22 once writes data received from the disk-format controller 23, reads the data at an appropriate timing from the buffer 30, and then transmits the data to the interface-protocol controller 21.

The size of the buffer 30 is generally 16 megabytes, which corresponds to 32 kilo-sectors with 512 bytes being as one sector (16×1024×1024/512=32768).

The disk-format controller 23 controls read and write of data stored in the storage medium 40. Specifically, at the time of reception of write data, the disk-format controller 23 transmits data received from the buffer controller 22 to the RDC 50. At the time of transmission of read data, the disk-format controller 23 transmits data received from the RDC 50 to the buffer controller 22.

The ECC calculator 24 generates and verifies ECC for preventing data error (data corruption) stored in the storage medium 40. Specifically, at the time of reception of write data, the ECC calculator 24 generates ECC code based on data received from the disk-format controller 23. The generated ECC code is stored in the storage medium 40 via the disk-format controller 23. At the time of transmission of read data, the ECC calculator 24 receives data and ECC code from the disk-format controller 23. Furthermore, the ECC calculator 24 calculates ECC code for the received data, compares the calculated ECC code and the received ECC code (stored in the storage medium 40 at the time of write) with each other, and then corrects the data as required.

The RDC 50 includes a write-system circuit and a read-system circuit. Specifically, the RDC 50 (write system) encodes data received from the disk-format controller 23 to code suitable for magnetic storage (Run-Length Limited Coding: RLL), and corrects interruption between bits occurring on the storage medium 40. The RDC 50 (read system) converts a read signal received from the HDIC 60 to a digital value for decoding through analog-digital conversion and Partial Response Maximum Likelihood (PRML) signal processing technology.

The HDIC 60 includes a write-system circuit and a read-system circuit. Specifically, the HDIC 60 (write system) converts “1” or “0” of a digital signal in a current direction so as to write data in the storage medium 40, and then causes the conversion result to a write head. The HDIC 60 (read system) amplifies (approximately 100-fold) a read signal (approximately 1 millivolt) converted by a read head to an electrical signal.

The storage device 10 according to the first embodiment includes, as depicted in FIG. 10, “SATA Phy layer” (hereinafter, “Phy layer 21a”), “SATA Link layer” (hereinafter, “link layer 21b”), and “SATA Transport layer” (hereinafter, “transport layer 21c”) in the interface-protocol controller 21 depicted in FIG. 9. The transport layer 21c in the first embodiment includes an internal register 21d and a comparator 21e. In FIG. 10, for convenience of explanation, only the interface-protocol controller 21 of the controller 20 depicted in FIG. 9 is depicted. Furthermore, an internal memory 21f is not necessarily provided to the interface-protocol controller 21, but may be provided at an arbitrary location inside of the controller 20.

As depicted in FIG. 10, the storage device 10 according to the first embodiment is configured to store test data in the internal register 21d inside of the controller 20 and also perform data comparison by the comparator 21e inside of the controller 20.

Specifically, the storage device 10 according to the first embodiment has arbitrary test patterns stored in the internal register 21d inside of the controller 20. The test-pattern length is restricted by the size of the internal register 21d. Here, 8 DWord (1 DWord=32 bits) is assumed.

The storage device 10 according to the first embodiment stores in an arbitrary location of the controller 20 (for example, the internal memory 21f) repeated data with the same patterns as the test patterns stored in the internal register 21d for one sector (128 DWords). The storage device 10 is set so as to repeatedly transmit data from the location in the controller 20 where data with the same patterns as the test patterns is stored. At this time, the data length to be transmitted from the controller 20 may be any number of sectors as long as only the sectors storing the test patterns are transmitted. Being set so at to repeatedly transmit data, the storage device 10 can increase accuracy in data comparison by the comparator 21e.

Furthermore, in the storage device 10 according to the first embodiment, as depicted in FIG. 10, a transmission interface (I/F) 11 and a reception interface (I/F) 12 are directly connected together outside of the controller 20. With such direct connection outside of the controller 20, the connection among the transport layer 21c, the link layer 21b, and the Phy layer 21a is verified, and also resistance to signal deterioration in an input/output (I/O) pad of the controller 20 or the cable is verified. Here, verifying resistance to signal deterioration means verifying whether correct data can be obtained through demodulation even if the signal deteriorates in midstream.

The comparator 21e verifies whether the transmitted test data is consistent with or matches the received test data. Specifically, the comparator 21e compares the test data stored in the internal register 21d and the test data received in the transport layer 21c with each other to verify whether they match.

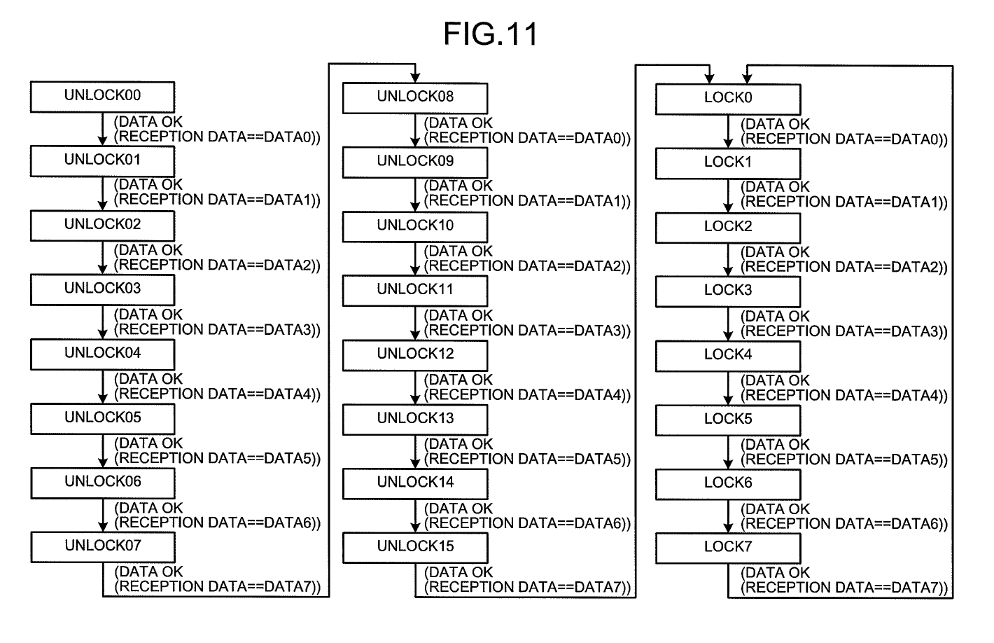

The operation of the comparator 21e is described in detail below with reference to FIGS. 11 and 12.

For example, the comparator 21e verifies consistency of the test data through the process depicted in FIGS. 11 and 12. First, the comparator 21e waits for the test data received in the transport layer 21c to become the first DWord in the test patterns. That is, the comparator 21e in the first embodiment waits for reception of “Data0” in the transport layer 21c. The comparator 21e manages state transitions and, when receiving “Data0”, causes the state to make a transition from “UNLOCK00” to “UNLOCK01”.

The data coming next to “Data0” is “Data1”. Therefore, after receiving “Data0”, the comparator 21e waits for reception of “Data1”. Then, when receiving “Data1”, the comparator 21e causes the state to make a transition from “UNLOCK01” to “UNLOCK02”, and then waits for reception of “Data2”. On the other hand, when the data received next is not “Data1”, the comparator 21e causes the state to make a transition from “UNLOCK01” to UNLOCK00” as depicted in FIG. 12, and then again waits for reception of “Data0”.

Here, there may be two reasons why “Data1” cannot be received (reasons for a state transition from “UNLOCK01” to “UNLOCK00”). One reason is that “Data1” has not been correctly transmitted and received. The other reason is that a state transition of “UNLOCK00” to “UNLOCK01” erroneously occurs due to influences, such as noise, to begin with. Since the latter reason is possible, the comparator 21e does not leave an error log at this point in time, as depicted in FIG. 12.

Meanwhile, the comparator 21e repeats the process explained above and, when the received data is changed in two cycles such that “Data0”→“Data1”→ . . . →“Data7”→“Data0”→“Data1”→ . . . →“Data7”, causes the state to make a transition to “LOCK”. In this manner, the comparator 21e in the first embodiment does not cause the state to make a transition to “LOCK” unless performing comparison on the received data in two cycles. With this, accuracy in data comparison can be increased. That is, the comparator 21e in the first embodiment can reduce the possibility of erroneously determining by chance, although the test data has not been transmitted, that the test data has been correctly received due to influences, such as noise, to almost zero. This is because it is thought to be unlikely to erroneously detect by chance that data of any test pattern has been received consecutively for 16 DWords.

After the state becomes “LOCK”, the comparator 21e determines a test error when the reception data becomes a pattern other than “Data0”→“Data1”→ . . . →“Data7”, and leaves an error log, as depicted in FIG. 12.

In this manner, upon completion of the test, when the state is “LOCK” and no error log is present, the comparator 21e determines that the test has been successful. On the other hand, upon completion of the test, when the state is “UNLOCK” or an error log is present, the comparator 21e determines that the test has failed.

As described above, according to the first embodiment, when the reception I/F and the transmission I/F are electrically connected together through a cable, for example, in response to an instruction for test mode, transmission of test data as well as reception of the transmitted test data is controlled according to a protocol set for the test mode. The comparator verifies whether the transmitted test data matches the received test data. Thus, a test on the interface unit can be easily performed.

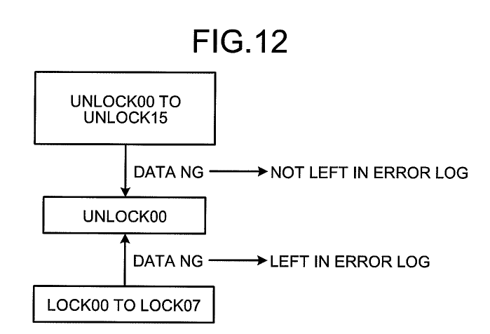

Modifications of the first embodiment are described below with reference to FIGS. 13A to 13E, 14A to 14C, 15A to 15C.

According to the first embodiment, the storage device is configured to store all data patterns of the test data in the controller and performs data comparison by the comparator also in the controller. Besides, the storage device is assumed to have a memory with a size sufficient to store all data patterns in the controller (the internal memory 21f is sufficiently large). However, this is by way of example only and not limiting. For example, the storage device may not necessarily have a memory in the controller that is sufficiently large to store all data patterns of the test data. In this case, as depicted in FIG. 13A, the storage device rewrites the test data on the memory from outside for each test, and repeats the test until desired data patterns are all covered.

The storage device may be configured to not only perform data comparison in the controller but also perform data comparison in the buffer. In this case, the storage device controls transmission of the test data stored in the controller and also controls reception of the test data to the buffer. That is, for example, the storage device is set in a manner such that, after data comparison is performed by the comparator in the controller (after determining whether the test has been successful or failed), the storage device transmits the data to the buffer and writes the data in the buffer. Then, the storage device additionally performs data comparison on the data on the buffer. For example, FIG. 13B illustrates an example of the storage device that includes a memory in the controller that is sufficiently large to store all data patterns of the test data. On the other hand, FIG. 13C illustrates an example of the storage device that does not include a memory in the controller that is sufficiently large to store all data patterns of the test data. In either case, in addition to the test on the transmission I/F and the reception I/F, a test on a write path from the controller to the buffer can be performed.

Further, the storage device may be configured to not only perform data comparison in the controller but also perform data comparison on the storage medium. In this case, the storage device controls transmission of the test data stored in the controller and also controls reception of the test data to the storage medium. That is, for example, the storage device is set in a manner such that, after data comparison is performed by the comparator in the controller (after determining whether the test has been successful or failed), the storage device transmits the data to the storage medium and writes the data in the storage medium. Then, the storage device additionally performs data comparison on the data on the storage medium. For example, FIG. 13D illustrates an example of the storage device that includes a memory in the controller that is sufficiently large to store all data patterns of the test data. On the other hand, FIG. 13E illustrates an example of the storage device that does not include a memory in the controller that is sufficiently large to store all data patterns of the test data. In either case, in addition to the test on the transmission I/F and the reception I/F and a test on a write path from the controller to the buffer, a test on a write path from the buffer to the storage medium can be performed.

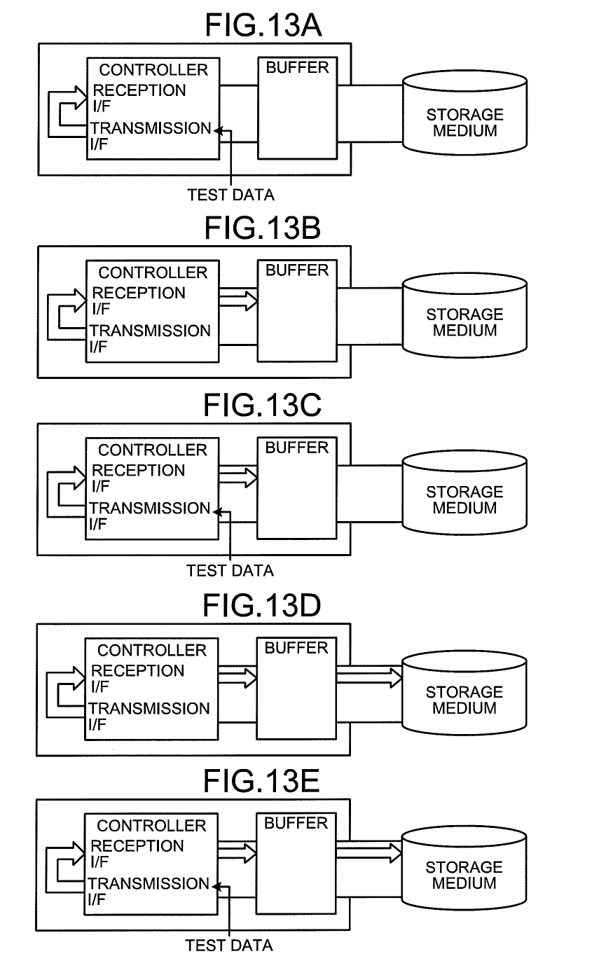

According to the first embodiment, the storage device is configured to store all data patterns of the test data in the controller and perform data comparison by the comparator also in the controller. However, this is by way of example only and not limiting. That is, the storage device may control transmission of the test data stored in the buffer and may also control reception of the test data to the buffer. For example, as depicted in FIG. 14A, the storage device may be configured to store the test data in the buffer, and not only perform data comparison in the controller but also perform data comparison on the buffer. In this case, in addition to the test on the transmission I/F and the reception I/F, a test on a read and write path between the controller and the buffer can be performed.

Still further, the storage device may control transmission of the test data stored in the buffer and may also control reception of the test data at the controller. For example, as depicted in FIG. 14B, the storage device may be configured to store the test data in the buffer and perform data comparison by the comparator in the controller. In this case, in addition to the test on the transmission I/F and the reception I/F, a test on a read path from the buffer to the controller can be performed.

Still further, the storage device may control transmission of the test data stored in the buffer and may also control reception of the test data to the storage medium. For example, as depicted in FIG. 14C, the storage device may be configured to store the test data in the buffer, and not only perform data comparison in the controller but also further perform data comparison on the storage medium. In this case, in addition to the test on the transmission I/F and the reception I/F, a test on a read and write path between the controller and the buffer and a test on a write path from the buffer to the storage medium can be performed.

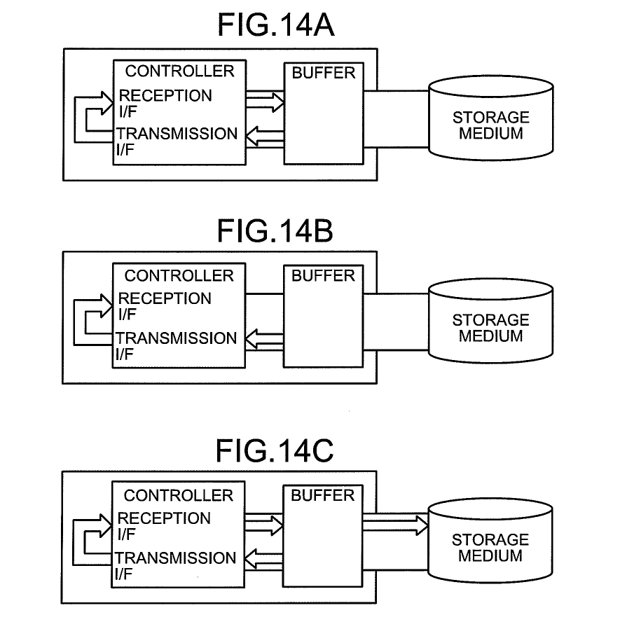

According to the first embodiment, the storage device is configured to store all data patterns of the test data in the controller and perform data comparison by the comparator also in the controller. However, this is by way of example only and not limiting. That is, the storage device may control transmission of the test data stored in the storage medium and may also control reception of the test data to the storage medium. For example, as depicted in FIG. 15A, the storage device may be configured to store the test data in the storage medium, and not only perform data comparison in the controller but also perform data comparison on the storage medium. In this case, in addition to the test on the transmission I/F and the reception I/F, a test on a read and write path between the controller and the buffer and a test on a read and write path between the buffer and the storage medium can be performed.

Still further, the storage device may control transmission of the test data stored in the storage medium and may also control reception of the test data at the buffer. For example, as depicted in FIG. 15B, the storage device may be configured to store the test data in the storage medium, and not only perform data comparison in the controller but also perform data comparison on the buffer. In this case, in addition to the test on the transmission I/F and the reception I/F, a test on a read and write path between the controller and the buffer and a test on a read path from the storage medium to the buffer can be performed.

Still further, the storage device may control transmission of the test data stored in the storage medium and may also control reception of the test data at the controller. For example, as depicted in FIG. 15C, the storage device may be configured to store the test data in the storage medium, and may perform data comparison by the comparator in the controller. In this case, in addition to the test on the transmission I/F and the reception I/F, a test on a read path from the storage medium to the buffer can be performed.

In the first embodiment, the reception I/F and the transmission I/F are described as being directly connected together through electrical connection with, for example, a cable; however, they may be directly connected together with a jig on a printed board.

Of the processes described above, all or part of the processes explained as being performed automatically can be performed manually, or all or part of the processes explained as being performed manually can be performed automatically with a known method. The processing procedures, the control procedures, specific names, and information including various data and parameters described above and illustrated in the drawings can be changed as required unless otherwise specified.

The constituent elements described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. All or any part of the processing functions performed by the devices can be realized by a CPU and a program analyzed and executed by the CPU, or can be realized as hardware by wired logic.

Still further, the test program explained in the embodiments can be distributed via a network, such as the Internet. The program can also be stored in a computer-readable storage medium, such as hard disk, flexible disk (FD), compact-disk read only memory (CD-ROM), magneto-optical disk (MO), and digital versatile disk (DVD), and read by the computer therefrom to be executed.

As set forth hereinabove, according to an embodiment, a test on an interface can be easily performed.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A storage device comprising:
a transmission controller that controls, in response to a test instruction to operate in test mode for testing whether data is correctly transmitted and received when a signal is output from a transmission interface and input to a reception interface, transmission of test data set for the test mode according to a protocol set for the test mode, the transmission interface for data transmission and the reception interface for data reception that, when electrically connected to the transmission interface, receives the signal from the transmission interface being interfaces connected to an external device;
a reception controller that controls, in response to the test instruction, reception of the test data transmitted under control of the transmission controller according to the protocol set for the test mode; and
a verifying unit that verifies whether the test data transmitted under control of the transmission controller matches the test data received under control of the reception controller.

2. The storage device according to claim 1, further comprising:
a controller that includes the transmission interface and the reception interface;
a buffer; and
a storage medium, wherein
the transmission controller controls transmission of the test data stored in the controller, and
the reception controller performs control such that the test data is received by the controller.

3. The storage device according to claim 1, further comprising:
a controller that includes the transmission interface and the reception interface;
a buffer; and
a storage medium, wherein
the transmission controller controls transmission of the test data stored in the controller, and
the reception controller performs control such that the test data is received by the buffer.

4. The storage device according to claim 1, further comprising:
a controller that includes the transmission interface and the reception interface;
a buffer; and
a storage medium, wherein
the transmission controller controls transmission of the test data stored in the controller, and
the reception controller performs control such that the test data is received by the storage medium.

5. The storage device according to claim 1, further comprising:
a controller that includes the transmission interface and the reception interface;
a buffer; and
a storage medium, wherein
the transmission controller controls transmission of the test data stored in the buffer, and
the reception controller performs control such that the test data is received by the buffer.

6. The storage device according to claim 1, further comprising:
a controller that includes the transmission interface and the reception interface;
a buffer; and
a storage medium, wherein
the transmission controller controls transmission of the test data stored in the buffer, and
the reception controller performs control such that the test data is received by the controller.

7. The storage device according to claim 1, further comprising:
a controller that includes the transmission interface and the reception interface;
a buffer; and
a storage medium, wherein
the transmission controller controls transmission of the test data stored in the buffer, and
the reception controller performs control such that the test data is received by the storage medium.

8. The storage device according to claim 1, further comprising:
a controller that includes the transmission interface and the reception interface;
a buffer; and
a storage medium, wherein
the transmission controller controls transmission of the test data stored in the storage medium, and the reception controller performs control such that the test data is received by the storage medium.

9. The storage device according to claim 1, further comprising:
a controller that includes the transmission interface and the reception interface;
a buffer; and
a storage medium, wherein
the transmission controller controls transmission of the test data stored in the storage medium, and the reception controller performs control such that the test data is received by the buffer.

10. The storage device according to claim 1, further comprising:
a controller that includes the transmission interface and the reception interface;
a buffer; and
a storage medium, wherein
the transmission controller controls transmission of the test data stored in the storage medium, and
the reception controller performs control such that the test data is received by the controller.
